(19) United States
(12) Patent Application Publication
(10) Pub. No.: US 2025/0269603 A1
(43) Pub. Date: Aug. 28, 2025

(54) DYNAMIC ALLOCATION OF OBJECTS TO BE MANUFACTURED TO ADDITIVE MANUFACTURING DEVICES

(71) Applicant: EOS GMBH ELECTRO OPTICAL SYSTEMS, Krailling (DE)

(72) Inventor: Alexander PRILLWITZ, München (DE)

(21) Appl. No.: 18/859,909

(22) PCT Filed: Mar. 15, 2023
(86) PCT No.: PCT/EP2023/056640

§ 371 Date: Oct. 24, 2024

(30) Foreign Application Priority Data
Apr. 25, 2022 (DE) 10 2022 109 945.8

(51) Int. Cl. B29C 64/393; B22F 10/85; B33Y 50/02

(52) U.S. Cl. CPC B29C 64/393; B22F 10/85; B33Y 50/02

(57) ABSTRACT

A computer-aided method of controlling a plurality of additive manufacturing apparatuses. The method includes receiving first computer-based data models each of which geometrically describes a first object to be manufactured, receiving status data and/or property parameters of the plurality of additive manufacturing apparatuses, to each of which at least one second computer-based data model of a second object to be manufactured has been assigned, transmitting a first computer-based data model to a target manufacturing apparatus among the plurality of additive manufacturing apparatuses for a manufacture of the first object, where the target manufacturing apparatus is selected on the basis of a rule-based automatic decision in which the received status data and/or property parameters are taken into account.

The present invention is related to a computer-aided method of controlling a number of additive manufacturing apparatuses, a corresponding control device for controlling the plurality of additive manufacturing apparatuses, a corresponding method for manufacturing the plurality of three-dimensional objects with the plurality of additive manufacturing apparatuses, a corresponding manufacturing system and an associated computer program.

Additive manufacturing apparatuses and associated methods, to which the invention is related in particular, are generally characterized in that objects are manufactured layer-by-layer thereby by solidifying a formless build material (e.g., a metal or plastic powder). The solidification can be brought about, for example, by supplying thermal energy to the build material by irradiating the same with electromagnetic radiation or particle radiation (e.g., laser sintering (SLS or DMLS) or laser melting or electron beam melting). For example, in laser sintering or laser melting, a laser beam is moved over those positions of a layer of the build material that correspond to the object cross-section of the object to be manufactured in this layer, so that the build material is solidified at these positions. After the build material has been melted or sintered at one position by the supply of thermal energy, the build material does no longer exist in a formless state after cooling, but as a solid body. After all positions of an object cross-section to be solidified have been scanned, a new layer of the build material is applied and likewise solidified at the positions corresponding to the cross-section of the object in this layer.

WO 2011/100978 A1 discloses a computer-implemented method for preparing a manufacturing process in an additive manufacturing apparatus. For this purpose, data models of a plurality of objects to be manufactured are integrated into a data set (referred to as batch) to be supplied to the additive manufacturing apparatus for the manufacturing, which data set specifies the position of the objects in the installation space. When arranging the objects in the construction space during their manufacturing, which is generally referred to as “nesting”, in particular a material consumption that is as low as possible is aimed at in the manufacturing process. After the generation of the data set (batch) to be supplied to the additive manufacturing apparatus has been completed, the data set is supplied to the additive manufacturing apparatus and the manufacturing process is started.

Usually, all objects to be manufactured at first are collected before a manufacturing process is started in a selected additive manufacturing apparatus. The reason is that a filling rate (also referred to as packing density) of the construction space of an additive manufacturing apparatus that is as high as possible is aimed at for a high efficiency. As soon as a manufacturing process has been started in the additive manufacturing apparatus, further objects to be manufactured in the manufacturing process can be additionally added to the additive manufacturing apparatus only if the manufacturing process is briefly interrupted. This is disadvantageous, on the one hand, because the quality of the objects in production is impaired by the interruption (stripe formation), on the other hand, the subsequent addition of objects to be manufactured leads to a reduction in the overall packing density during a manufacturing process.

Therefore, the object of the present invention is the provision an automated method and an associated device for controlling a plurality of additive manufacturing apparatuses, making it possible to assign without adverse effects further objects to be manufactured to an additive manufacturing apparatus in which a manufacturing process is already running.

The object is achieved by a method according to claim 1 and a device according to claim 12. Developments of the invention are claimed in the dependent claims. In particular, a device according to the invention can also be developed by features of the methods according to the invention set out below or in the dependent claims, and vice versa. Furthermore, the features described in connection with a device according to the invention can also be used to develop another device according to the invention, even if this is not explicitly stated.

An inventive computer-based method for controlling a plurality of additive manufacturing apparatuses, each of which is suitable for simultaneously manufacturing a plurality of three-dimensional objects, wherein an object is manufactured by means of an additive manufacturing apparatus by applying and solidifying a building material,
wherein a manufacturing process in each of the additive manufacturing apparatuses is controlled in each case by a control data set that specifies the position and orientation of the objects to be manufactured in a construction space of the additive manufacturing apparatus, comprises the following steps:
receiving a number of first computer-based data models each of which geometrically describes a first object to be manufactured by means of an additive manufacturing apparatus,
receiving status data and/or property parameters of a plurality of additive manufacturing apparatuses, to each of which at least one second computer-based data model of a second object to be manufactured in the additive manufacturing apparatus has been assigned,
transmitting at least one first computer-based data model to a target manufacturing apparatus selected from the plurality of additive manufacturing apparatuses for a manufacture of the first object described by the first computer-based data model by means of the target manufacturing apparatus,
wherein the target manufacturing apparatus to which the at least one first computer-based data model is transmitted is selected on the basis of a rule-based automatic decision in which the received status data and/or property parameters are taken into account.

In particular, the additive manufacturing apparatus may be an apparatus in which objects are manufactured by applying a build material layer-by-layer and solidifying the build material in a build plane by means of supplying radiation energy to positions in each layer that are assigned to the cross-section of the object in this layer. In addition, however, an application in connection with other additive manufacturing apparatuses is also possible, for example FLM (fused layer modeling) apparatuses in which heated thermoplastic material is deposited on a substrate.

Here, a control data set (often also referred to as a control command set) is considered to be, in particular, a sequence of instructions to apply layers of the build material one after the other and to scan regions of the respective layers that correspond to the cross-section of an object to be manufactured with radiation in order to solidify the build material. In the case of FLM apparatuses, a control data set is considered to be a sequence of instructions to apply heated build material at positions of regions that correspond to the finished object after process termination.

In detail, a control data set is based on a data model of the object or objects to be manufactured, preferably a CAD model. The control data set defines, for each layer during manufacturing, the positions at which a solidification of the build material is to be brought about by supply of radiation, and optionally a thickness of the layer. Furthermore, a control data set generally also contains manufacturing-apparatus-specific information, for example with regard to the position and orientation of the objects in the additive manufacturing apparatus.

A first or second computer-based data model is generally a 3D CAD model of an object to be manufactured. In this case, the model can also already exist in the STL format or contain layer information about the individual layers in the intended manufacturing process by a generative layer manufacturing method. Preferably, the second computer-based data model is already part of a control data set of an additive manufacturing apparatus, whereas this is not yet the case for the first computer-based data model. Furthermore, it should also be noted at this point that, in the present application, the term “number” is always to be understood in the sense of “one or more”.

Optionally, the following information (object parameters) can also be added to a first data model:
the preferred orientation of the object to be manufactured in the construction space during its manufacturing
the preferred build material for manufacturing the object
specifications for the preferred layer thickness to be used during manufacturing

specifications for the preferred exposure strategy to be applied, i.e., the manner in which e.g. a laser beam is moved across a layer of the build material in order to solidify the build material
the desired number of first objects to be manufactured
an indication of whether a plurality of laser beams can be used simultaneously during the manufacturing of the first objects in order to solidify the build material within a cross-section of the object
an indication of whether all first objects are to be manufactured together in one additive manufacturing apparatus or whether an allocation to a plurality of manufacturing apparatuses is possible
are data models that have already been assigned for a manufacturing process to a specific additive manufacturing apparatus allowed to be assigned to another additive manufacturing apparatus?

The additional information can be added to a first data model, for example, by encoding the information in the name of the file containing the first data model, thus e., by attaching e.g. “_5” to the file name in order to indicate that the desired number is five. If object parameters, such as the build material to be used, are left open, this creates options for assigning a data model to an additive manufacturing apparatus.

Status data of an additive manufacturing apparatus are in particular information about the current operating state. Property parameters are in particular parameters (values) that describe technical characteristics of an additive manufacturing apparatus. In particular, these status data/property parameters of a control device of the additive manufacturing apparatuses are transmitted autonomously by the additive manufacturing apparatuses.

Examples of status data are the following:
Admissibility of the addition of further objects to the second objects already assigned to the additive manufacturing apparatus (there may be reasons on the basis of which the manufacturing process of the second objects should be terminated as quickly as possible, e.g. when the second objects are urgently needed: in this case, an additional manufacture of other objects would lead to undesired delays)
the build material that is currently being used in the additive manufacturing apparatus
the layer thicknesses with which a manufacturing process of the second objects is to run
the current height of the layer stack already partially solidified during a building process of the second objects, i.e., the total thickness of the layers already applied during the building process
the initial total height (total thickness of the applied layers) that is needed for the manufacture of all second objects
the packing density in the construction space of an additive manufacturing apparatus that results when only the second objects are manufactured in this manufacturing apparatus; the packing density is defined here as the ratio between the total volume of the objects to be manufactured and the total volume of the construction space
the final total height (total thickness of the applied layers) that is needed for the manufacture of the second objects

Examples of property parameters are the following:
the type of build material that can be processed in an additive manufacturing apparatus
the total volume of the construction space of an additive manufacturing apparatus

Further parameters can be interpreted both as property parameters and as status data. These are in particular the following:
an initial packing density (aPd), which indicates which minimum packing density must be present in the first layers in order for a manufacturing process to be started; the choice of the initial packing density depends on how much unsolidified powder that must be recycled or disposed of, can be tolerated in order for a manufacturing process to be still profitable: in particular, an additive manufacturing apparatus could also autonomously determine which packing density is present at a start of a manufacturing process and automatically start the manufacturing process when the initial packing density is exceeded; as a result of the procedure according to the invention, it is in particular possible to start a manufacturing process with a low packing density, since further objects to be manufactured are added in the further course of the manufacturing process.
the maximum possible height of the construction space that is available in an additive manufacturing apparatus for a manufacturing process, also referred to as maximum job height (mJh); the maximum job height is dependent on the maximum construction space height of the additive manufacturing apparatus, but can also be limited by the maximum construction height at which a build material can still be used in a process-stable manner; since the cooling time after the end of the manufacturing process also increases with increasing job height, the maximum job height can also be limited by the length of the cooling time still to be waited for after the end of a manufacturing process; furthermore, the maximum job height can also be limited by the aging characteristic of the build material, since the build material that remains unsolidified and should be reused if possible ages more strongly with increasing job height as a result of the longer temperature load.
the maximum packing density (mPd), that is to say the maximum possible ratio between the volume of all objects to be manufactured and the construction space volume; since the thermal conditions within the construction space are usually more difficult to control with increasing packing density, a maximum value for the packing density can be predefined
a holding time (HT), which is a waiting time in which a manufacturing apparatus is held at an elevated temperature, for example at the working temperature or somewhat below the same, in order to wait for further objects to be manufactured in the current manufacturing process before the manufacturing apparatus is cooled;

For the sake of simplicity, sometimes only status data or else status and property parameters are referred to below, although always status data and property parameters are meant.

On the basis of the first and second data models and the status data/property parameters of the plurality of additive manufacturing apparatuses that theoretically are available for the manufacture of the first objects, it is possible to determine in an automated manner, on the basis of predetermined decision rules, to which target manufacturing apparatus the first data models are assigned for a manufacture of the first objects. Since no manual intervention is necessary for an assignment of the first data models to a target manufacturing apparatus, a manufacturing process in the target manufacturing apparatus in particular does not have to be interrupted for such an assignment. This also has the further advantage that the objects to be manufactured can be completed more quickly, since there is no need to wait until sufficient objects are available for an economic manufacturing process, but a manufacturing process can already be started with initially only a few objects.

Rules on which a decision about the assignment of first data models to a target manufacturing apparatus is based can be, for example, the following:
Achieving a use of build material that is as efficient as possible (accompanying a packing density that is as high as possible during a manufacturing process in a manufacturing apparatus, since then less build material has to be disposed of or recycled).
Limiting the maximum duration of a manufacturing process running in a manufacturing apparatus.
Assigning the first data models to that additive manufacturing apparatus in which the manufacturing process including the first objects will come to an end as quickly as possible, so that the first objects can be removed from the manufacturing apparatus; when implementing this rule, it is also possible, for example, to check how long the cooling time of an additive manufacturing apparatus is, which is proportional to the job height;
Is the allowable maximum packing density and/or maximum job height specified for the eligible additive manufacturing apparatus exceeded by the assignment of the first data models?

When applying the rules, a prioritization of rules can take place. For example, the most important decision criterion, could be considered to be that, after the assignment of the first data models to an additive manufacturing apparatus, a ratio of the resulting packing density to the resulting final total height is as high as possible. Here, in the background there is the idea that, for a high efficiency, the packing density should be as high as possible and that, e.g. for a rapid cooling process, the final total height should be limited.

If a manufacturing process of the second objects is already running in the additive manufacturing apparatus to which the first data model is assigned, it is preferably determined which of the second objects can still be arranged at other locations in the construction space, since their manufacture has not yet begun. In this case, the length of time needed for the nesting process of the arrangement of the first objects in the construction space can also be taken into account.

It should also be mentioned that a manufacturing apparatus in which a manufacturing process of all data models already assigned to it has already come to an end and which (during the above-mentioned holding time) is held in readiness for still expected manufacturing processes can also be considered as a target manufacturing apparatus.

Further advantages due to the described approach are the following:

Due to the better utilization of the available construction space of an additive manufacturing apparatus, the manufacturing costs of an object can be massively reduced.

A user is not required to decide by himself on which manufacturing apparatus objects are to be built. In particular due to the high amount of data, the user will generally not be able to make a decision in the short term.

The downtime of the individual additive manufacturing apparatuses is reduced, since there is no need to wait until sufficient parts for a common manufacture in a common manufacturing process have accumulated.

In a further development of the invention, in the method, the number of control data sets of the number of additive manufacturing apparatuses is modified by way of trial such that a modified control data set specifies in each case the position and orientation of the number of first objects and the number of second objects in the construction space of the respective active additive manufacturing apparatus, and
the target manufacturing apparatus for a manufacture of the first objects described by the number of first computer-based data models is selected on the basis of the control data sets modified by way of trial.

On the basis of the multitude of information made available to it, a control device of a plurality of additive manufacturing apparatuses is able to simulate autonomously whether an addition of the first objects to a manufacturing process that is intended for a specific additive manufacturing apparatus leads to a result that does not lead to any violation of the boundary conditions predetermined by the property parameters and by the current state of the specific additive manufacturing apparatus.

In a further development of the invention, the status data received from the additive manufacturing apparatuses can contain information about the construction progress in the manufacture of second objects.

The information about the construction progress can be important in cases in which second objects already under construction have to be completed (have to be removed from the manufacturing apparatus) within a given period of time.

In a further development of the invention, the at least one first computer-based data model is transmitted to a target manufacturing apparatus in which the manufacture of a second object has already started.

Due to the approach according to the invention, it is in particular possible to assign further objects to be manufactured to an additive manufacturing apparatus, although a manufacturing process has already started in the manufacturing apparatus.

In a further development of the invention, placement information is transmitted to the target manufacturing apparatus, which placement information specifies a placement of the first objects in a construction space of the additive manufacturing apparatus such that at least one first object and at least one second object are manufactured with temporal overlap.

A particularly high packing density can be achieved in particular when the newly added first objects are not only manufactured in the additive manufacturing apparatus when the manufacture of the already assigned second objects has been completed. Preferably, the first objects are placed in the construction space such that cross-sections of the first objects and of the second objects are simultaneously solidified within a layer.

In a further development of the invention, the property parameters can specify a maximum total packing density and/or minimum a total construction height in the target manufacturing apparatus that can be achieved for specified boundary conditions.

The specification of a maximum total packing density can be meaningful when it is very important during the manufacture of the objects from a specific build material that a desired temperature distribution in the construction space is maintained as accurately as possible. This is because it should be taken into account here that with increasing packing density it can be more difficult to ensure a desired temperature distribution in the construction space. The specification of a minimum total construction height leads to first objects preferably being assigned to an additive manufacturing apparatus in which the minimum total construction height is exceeded after the manufacture of the first objects. The specification of the minimum total construction height can therefore lead to the first objects being obtained as quickly as possible.

In a still further development of the invention, the status data contain information about the packing density and/or construction height resulting from the manufacture of the second objects in the additive manufacturing apparatus and
the rule-based decision takes into account the total packing density and/or total construction height resulting from the joint manufacture of first and second objects in the additive manufacturing apparatus.

The information about the packing density and/or construction height resulting from the manufacture of the second objects in the additive manufacturing apparatus facilitates the determination of the total packing density or job height obtained due to the addition of the first objects.

In a still further development of the invention, the rule-based decision takes into account the change in the packing density and/or construction height respectively resulting from the joint manufacture of first and second objects in an additive manufacturing apparatus.

In such an approach, it can be aimed at, for example, ensuring a change as low as possible of the packing density that results from the addition of the first objects, since, as already mentioned, the packing density can have an influence on the temperature distribution in the construction space.

In a still further development of the invention, the rule-based decision is made in such a way that a first computer-based data model is transmitted to that additive manufacturing apparatus for which, in comparison to the other ones of the plurality of additive manufacturing apparatuses, the packing density resulting from the joint manufacture of first and second objects in the additive manufacturing apparatus assumes a maximum value and/or the total construction height resulting from the joint manufacture of first and second objects in the additive manufacturing apparatus assumes a minimum value.

A maximum value of the packing density resulting from the addition of the first objects leads to a utilization of build material that is as efficient as possible. A minimum value of the total construction height resulting from the addition of the first objects leads to a reduction of the cooling time of the additive manufacturing apparatus after the termination of the manufacturing process.

In a further development of the invention, at least one second computer-based data model of a second object to be manufactured in the target manufacturing apparatus, the manufacture of which has not yet been started before the transmission of the at least one first computer-based data model, is transferred to an additive manufacturing apparatus other than the target manufacturing apparatus in order to be manufactured in the other manufacturing apparatus.

If a second computer-based data model of a second object, the manufacture of which has not yet been started in the target manufacturing apparatus, is assigned for a manufacturing process to another manufacturing apparatus, then overall advantages can result therefrom. Then, in the target manufacturing apparatus, first objects can be manufactured, the manufacture of which would otherwise possibly have had to be stayed as a suitable target manufacturing apparatus is not yet available. Preferably, the second objects are assigned to another manufacturing apparatus in which the manufacture of the second objects can start immediately.

In a further development of the invention, the control data set specifies the manufacture of generic support structures, which can serve as support structures for added first objects during the manufacturing process of the same, for at least one, preferably for all, of the plurality of additive manufacturing apparatuses, to each of which at least one second computer-based data model of a second object to be manufactured in the additive manufacturing apparatus has been assigned.

Depending on the build material used, it may be necessary to support objects to be manufactured by support structures during the manufacturing process so that they keep their position in the installation space and do not change their shape. If the control data set of an additive manufacturing apparatus, to which a second data model for the manufacture of second objects has already been assigned, specifies in addition the manufacture of generic support structures, these generic support structures can then be used for the manufacture of first objects to be assigned to the additive manufacturing apparatus. Under certain circumstances, an assignment of first objects to a specific additive manufacturing apparatus would otherwise not be possible at all.

In a further development of the invention, object parameters (BPn) are received in addition to the first data models, which object parameters specify boundary conditions for the additive manufacture of objects that are geometrically described by the first data models.

Examples of possible object parameters have been specified further above. In connection with the description of embodiments, examples of possible object parameters are also given further below-referred to there as part parameters.

An inventive control device for controlling a plurality of additive manufacturing apparatuses, each of which is suitable for simultaneously manufacturing a plurality of three-dimensional objects, wherein an object is manufactured by means of an additive manufacturing apparatus by applying and solidifying a building material, comprises:
an object data input interface for receiving a plurality of first computer-based data models each of which geometrically describes a first object to be manufactured by means of an additive manufacturing apparatus,
a status data input interface for receiving status data of a number of additive manufacturing apparatuses, to each of which at least one second computer-based data model of a second object to be manufactured in the additive manufacturing apparatus has been assigned,
an object data output interface for transmitting at least one first computer-based data model to a target manufacturing apparatus selected from the plurality of additive manufacturing apparatuses for a manufacture of the first object described by the first computer-based data model by means of the target manufacturing apparatus, and
a decision unit which is configured to select the target manufacturing apparatus to which the at least one first computer-based data model is transmitted on the basis of a rule-based automatic decision in which the received status data and/or property parameters are taken into account.

In particular, the additive manufacturing apparatus may be an apparatus in which objects are manufactured by applying a build material layer-by-layer and solidifying the build material in a build plane by means of supplying radiation energy to positions in each layer that are assigned to the cross-section of the object in this layer. However, an application in connection with other additive manufacturing apparatuses is also possible, for example FLM (fused layer modeling) apparatuses in which heated thermoplastic material is deposited on a substrate.

The control device can be imagined to be a distribution center that receives data models of objects (parts) to be manufactured and assigns them to one or more of the manufacturing apparatuses connected to the control device for a manufacturing process of a number of the objects. The computer-based data models can be supplied to the control device by a data model generation or preparation unit connected to the control device via a network, for example by a design computer or a computer that serves to adapt the data models to a specific manufacturing process or, for example, to section a data model into layers, to determine the orientation in space of the object to be manufactured during the manufacture or to assign metadata or part parameters to the data model, such as the preferred layer thickness, to determine the build material to be used during the additive manufacture, etc. Further examples of possible part parameters are listed in connection with the description of embodiments.

A control device according to the invention can be implemented not only by hardware components alone, but also solely by software components or mixtures of hardware and software. For example, it can be a software package that is installed on a computer that is connected by cables or by means of radio to the plurality of manufacturing apparatuses or components from which data models are received.

Interfaces mentioned in the present application do not necessarily have to be designed as hardware components, but can also be implemented as software modules, for example if the data fed in or output via them can be received from other components already implemented on the same device or need to be transferred to another component merely by software. The interfaces could also consist of hardware and software components, such as a standard hardware interface, which is specially configured by software for the specific purpose. In addition, a plurality of interfaces can also be combined in a common interface, for example an input-output interface.

For a rule-based automatic decision, the decision unit is preferably designed as an expert system. The rule base can preferably be influenced by the user in that, for example, a hierarchy of criteria to be taken into account in the decision is determined.

An inventive method of manufacturing a plurality of three-dimensional objects with a plurality of additive manufacturing apparatuses, each of which is suitable for simultaneously manufacturing a plurality of three-dimensional objects, wherein an object is manufactured by means of an additive manufacturing apparatus by applying and solidifying a building material, comprises an inventive computer-based method for controlling a plurality of additive manufacturing apparatuses.

In particular, the additive manufacturing apparatus may be an apparatus in which objects are manufactured by applying a build material layer-by-layer and solidifying the build material in a build plane by means of supplying radiation energy to positions in each layer that are assigned to the cross-section of the object in this layer. In addition, however, an application in connection with other additive manufacturing apparatuses is also possible, for example FLM (fused layer modeling) apparatuses in which heated thermoplastic material is deposited on a substrate.

By means of the mentioned method of manufacturing a plurality of three-dimensional objects, these objects can be manufactured more cost-effectively. In particular, the advantages specified further above in connection with the inventive method of controlling a plurality of additive manufacturing apparatuses will result.

In a further development of the method of manufacturing a plurality of three-dimensional objects, in which the manufacture of a second object, to which a second computer-based data model has been assigned, has already started in the target manufacturing apparatus, the manufacture is continued without interrupting the manufacturing process, wherein after the transmission of the first computer-based data model both the first object and the second object are manufactured by the target manufacturing apparatus.

By means of the mentioned method, an interruption of a running manufacturing process can be avoided in particular by the control apparatus communicating automatically with the selected target manufacturing apparatus.

An inventive manufacturing system comprises a plurality of additive manufacturing apparatuses, each of which is suitable for manufacturing a plurality of three-dimensional objects with temporal overlap, in particular simultaneously, wherein an object is manufactured by means of an additive manufacturing apparatus by applying and solidifying the building material, and an inventive control device connected to the plurality of additive manufacturing apparatuses for controlling a plurality of additive manufacturing apparatuses.

In particular, the additive manufacturing apparatus may be an apparatus in which objects are manufactured by applying a build material layer-by-layer and solidifying the build material in a build plane by supplying radiation energy to positions in each layer that are assigned to the cross-section of the object in this layer. In addition, however, an application in connection with other additive manufacturing apparatuses is also possible, for example FLM (fused layer modeling) apparatuses in which heated thermoplastic material is deposited on a substrate.

With the manufacturing system according to the invention, the plurality of manufacturing apparatuses can be operated efficiently with a high throughput.

An inventive computer program comprises program code means for executing all steps of an inventive method of controlling a plurality of additive manufacturing apparatuses when the computer program is executed by means of a data processor, in particular a data processor interacting with an additive manufacturing apparatus.

The implementation of the inventive method as a computer program enables a fast installability (for example at the operator of a park of additive manufacturing apparatuses to which customers transfer data models of components to be manufactured for them).

Further features and utilities of the invention will result from the description of embodiments with reference to the attached drawings.

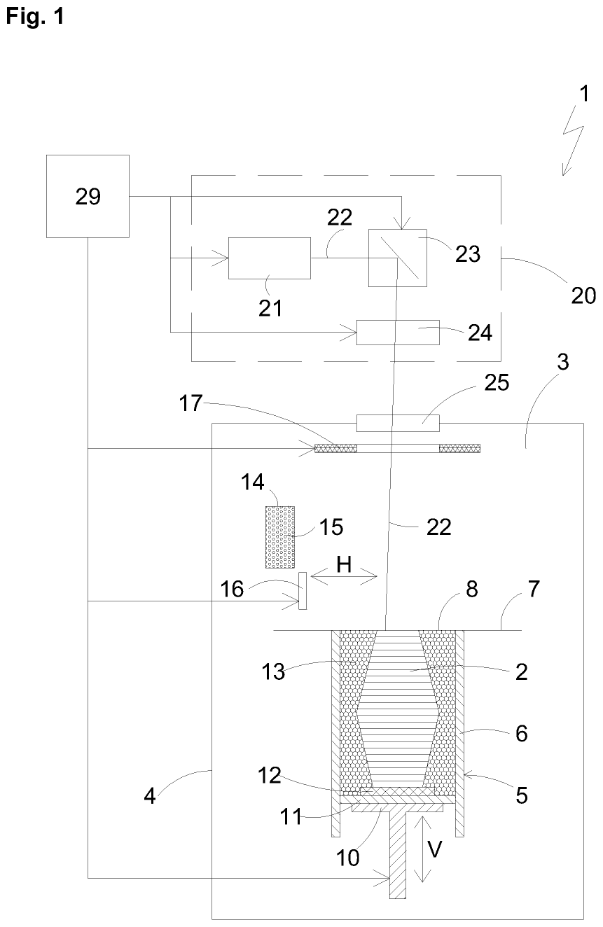

FIG. 1 shows a schematic, partially sectional view of an exemplary apparatus for generatively manufacturing a three-dimensional object according to an embodiment of the invention.

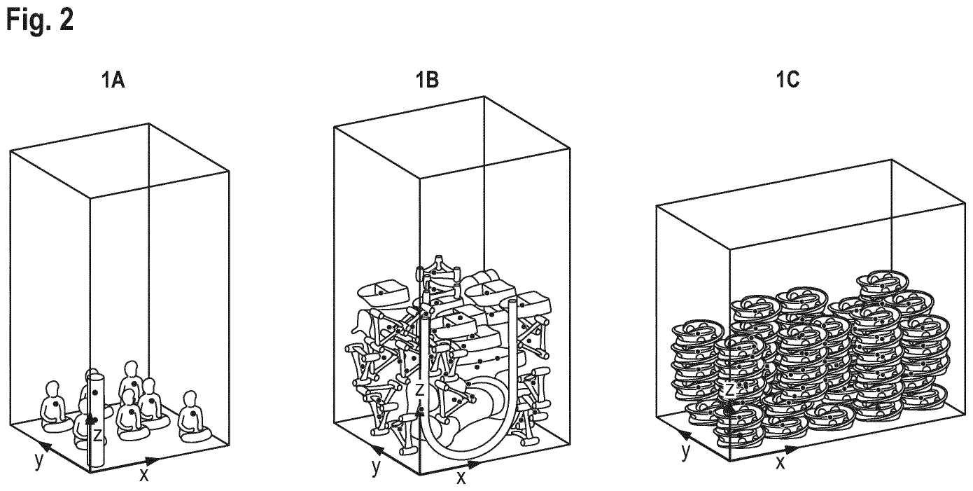

FIG. 2 shows the construction spaces of three additive manufacturing apparatuses to each of which parts to be manufactured have already been assigned.

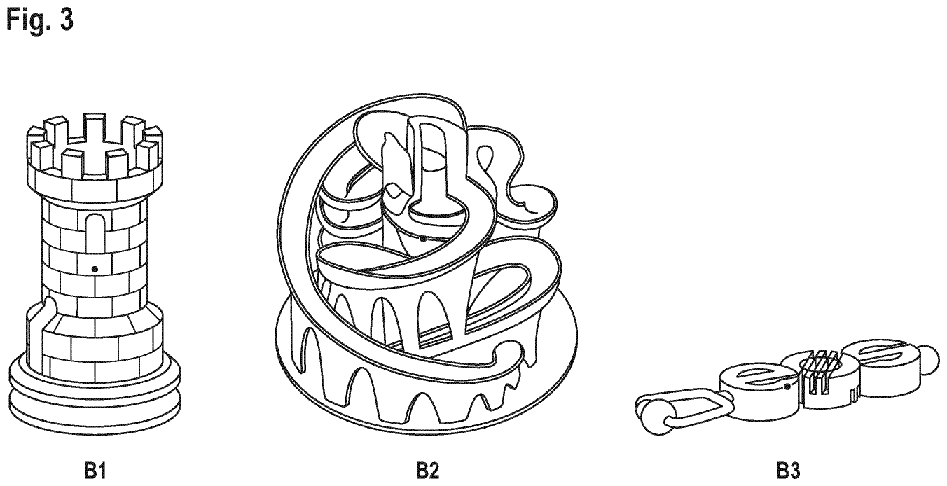

FIG. 3 shows a representation of three exemplary parts, the data models of which are to be assigned in each case to one of a plurality of existing manufacturing apparatuses.

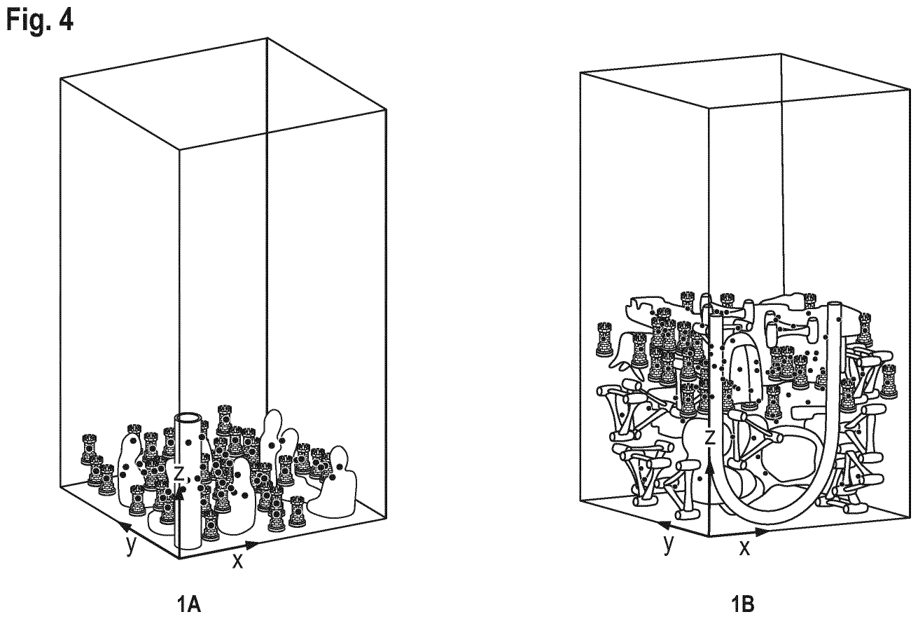

FIG. 4 shows the construction spaces of two additive manufacturing apparatuses after further parts have been arranged therein by way of trial.

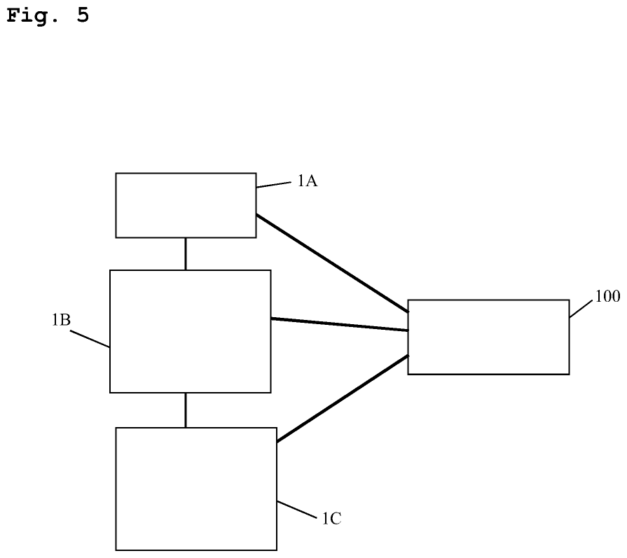

FIG. 5 schematically shows an example of an inventive system for controlling a plurality of additive manufacturing apparatuses.

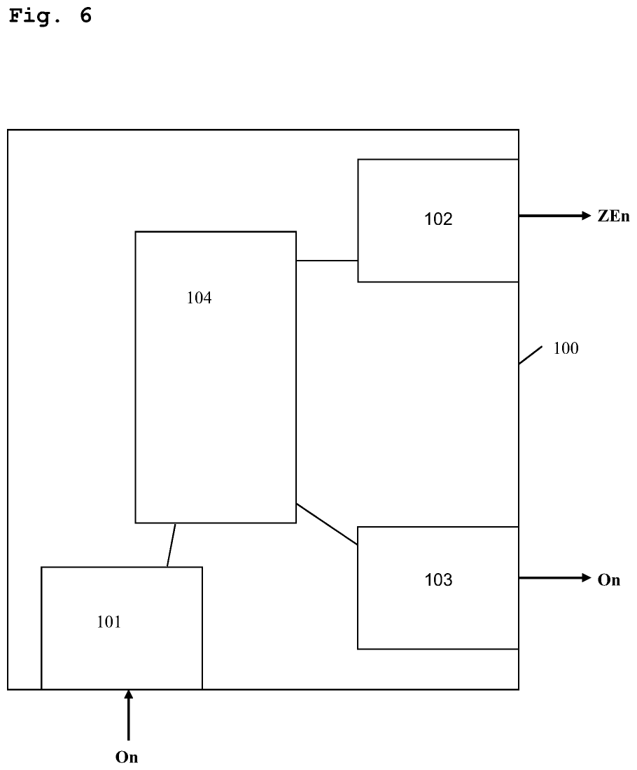

FIG. 6 shows a schematic setup of a control device.

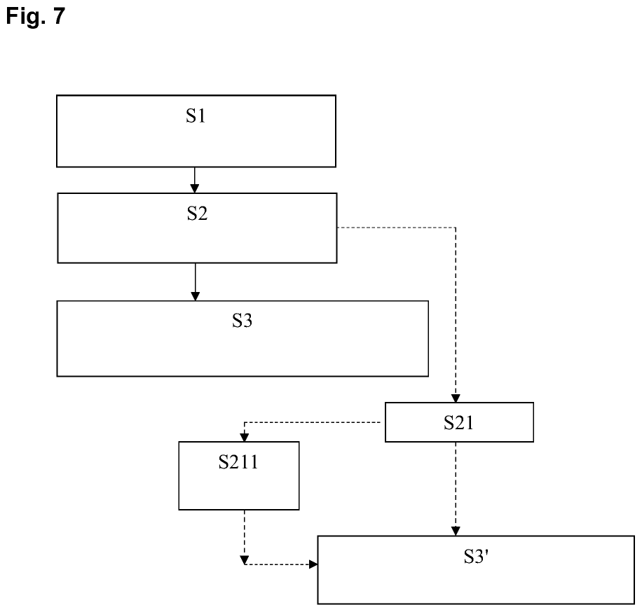

FIG. 7 schematically shows the sequence of an inventive method for controlling a plurality of additive manufacturing apparatuses.

First, an exemplary additive manufacturing apparatus according to the embodiments of the present invention is described below with reference to FIG. 1. The apparatus shown in FIG. 1 is a laser sintering or laser melting apparatus 1. For building up an object 2, it contains a process chamber 3 having a chamber wall 4. A construction container 5 which is open at the top and has a container wall 6 is arranged in the process chamber 3. A working plane or construction plane 7 is defined by the upper opening of the construction container 5, wherein the region of the working plane 7 that lies within the opening and can be used for building up the object 2 is referred to as a construction field 8.

Arranged in the construction container 5 is a carrier 10 that can be moved in a vertical direction V and to which a base plate 11 is attached that closes off the container 5 at the bottom and thus forms the bottom thereof. The base plate 11 can be a plate that is formed separately from the carrier 10 and is fastened to the carrier 10, or it can be formed integrally with the carrier 10. Depending on the powder and process used, a construction platform 12 can be additionally attached to the base plate 11 as a construction support, on which the object 2 is built up. However, the object 2 can also be built up on the base plate 11 itself, which then serves as a construction support. FIG. 1 shows the object 2 to be formed in the container 5 on the construction platform 12 below the working plane 7 in an intermediate state with a plurality of solidified layers surrounded by build material 13 that has remained unsolidified. The space within the construction container 5 that is delimited at the top by the working plane 7 and at the bottom by the base plate 11 is also referred to as construction space.

The laser sintering or laser melting apparatus 1 furthermore contains a storage container 14 for a build material 15, in this example a powder that can be solidified by electromagnetic radiation, and a coater 16 that can be moved in a horizontal direction H for applying the build material 15 within the construction field 8. Optionally, a heating apparatus, for example a radiant heating 17, can be arranged in the process chamber 3, which heating apparatus serves for heating the applied build material. By way of example, an infrared radiator can be provided as radiant heating 17.

The exemplary additive manufacturing apparatus 1 furthermore contains an energy input device 20 having a laser 21, which generates a laser beam 22 that is deflected via a beam deflection 23, for example one or more galvanometer mirrors, and is focused onto the working plane 7 by a focusing device 24 via a coupling-in window 25 that is attached to the upper side of the process chamber 3 in the chamber wall 4.

For the present invention, the specific setup of a laser sintering or laser melting apparatus shown in FIG. 1 is only by way of example and can of course also be modified, in particular when using an energy input device other than the one shown. In particular, it is also possible in the additive manufacturing apparatus 1 to manufacture a plurality of objects and not just one as in FIG. 1.

The laser sintering apparatus 1 furthermore contains a control device 29, by which the individual components of the apparatus 1 are controlled by means of a control data set in a coordinated manner for carrying out the construction process. Alternatively, the control device can also be installed partially or entirely outside the additive manufacturing apparatus. The control device can contain a CPU, the operation of which is controlled by a computer program (software). The computer program can be stored separately from the additive manufacturing apparatus in a storage device, from where it can be loaded (e.g. via a network) into the additive manufacturing apparatus, in particular into the control device.

In the present application, the term “control device” includes any computer-based control device that is able to control or regulate the operation of an additive manufacturing apparatus or of at least one of the components thereof. In this case, the connection between control device and controlled components does not necessarily have to be cable-based, but rather can also be implemented by means of radio, in that the control device has corresponding radio receivers and radio transmitters.

In operation, the carrier 10 is lowered layer by layer by the control device 29, the coater 16 is activated to apply a new powder layer, and the energy input device 20, i.e., in particular the beam deflection 23 and optionally also the laser 21 and/or the focusing device 24, is activated to solidify the respective layer at the positions corresponding to the respective object(s) by scanning these positions with the laser.

FIG. 5 schematically shows an example of an inventive system for controlling a plurality of additive manufacturing apparatuses. In FIG. 5, by way of example, three additive manufacturing apparatuses 1A, 1B and 1C are connected to a control device 100 for controlling these additive manufacturing apparatuses.

A setup of the control device 100 is shown schematically in FIG. 6. It has an object data input interface 101 for receiving a number of first computer-based data models (On), each of which geometrically describes a first object to be manufactured by means of an additive manufacturing apparatus. For example, the data models of the object data input interface 101 can be supplied by a database or a design system on which CAD models of objects to be manufactured are generated. Here, the data transmission can be cable-based or by radio. In particular, the object data input interface 101 can be connected to a network suitable for data transmission. In other words, the data transmission can optionally also take place over long distances (e.g., via the Internet).

Furthermore, the control apparatus 100 comprises a status data input interface 102 for receiving status and property parameters (ZEn) of a plurality of additive manufacturing apparatuses, to each of which at least one second computer-based data model of a second object to be manufactured in the additive manufacturing apparatus has been assigned. In FIG. 5, this would be status and property parameters of the manufacturing apparatuses 1A, 1B and 1C.

A decision unit 104, for example in the form of a CPU, serves for processing the data supplied via the object data input interface 101 and the status data input interface 102. As a result, the decision unit 104 makes a decision as to which of the manufacturing apparatuses 1A, 1B or 1C a data model supplied via the object data input interface 101 is to be supplied for the manufacture of the object associated with the data model. One or more of the first data models (On) are then transmitted to this manufacturing apparatus, also referred to below as target manufacturing apparatus, via the object data output interface 103.

An exemplary mode of operation of the decision unit 104 is explained below with reference to some examples.

FIG. 2 shows the construction spaces of three additive manufacturing apparatuses 1A, 1B and 1C to each of which parts to be manufactured have already been assigned. In the control data set of each of these manufacturing apparatuses, a manufacturing process of an object to be manufactured in the respective apparatus has already been specified. For each of the three construction spaces, by way of example, status and property parameters ZE0 to ZE9 are specified.

| Apparatus | 1A | 1B | 1C |
|---|---|---|---|
| during build operation (ZE0) | no | yes | yes |
| clearance for addition of objects | yes | yes | yes |
| (ZE1) | | | |
| material (ZE2) | PA2200 | PA2200 | PA1102 |
| layer thickness (ZE3) | 120 μm | 100 μm | 120 μm |
| current height layer stack (ZE4) | 0 | 150 mm | 80 mm |
| current packing density (ZE5) | 4% | 9.6% | 10% |
| initial total height (ZE6) | 200 mm | 316 mm | 295 mm |
| initial packing density (ZE7) | 6% | 6% | 6% |
| maximum job height (ZE8) | 320 mm | 320 mm | 450 mm |
| maximum packing density (ZE9) | 15% | 15% | 15% |

In the following, it is assumed that in the course of a day orders for the fastest possible manufacture of three different parts are received by the control apparatus 100, specifically for a first component B1 at 9 a.m., for a second component B2 at 1 p.m. and for a third component B3 at 6 p.m. This means that at the specified points in time the respective data model O1 or O2 or O3 of the first and second and third part, respectively, is supplied to the control device 100 via the object data input interface 101. The shape of the parts B1 to B3 is shown in FIG. 3.

The status and property parameters ZE0 to ZE9 listed above are transmitted to the decision unit 104 from the three existing additive manufacturing apparatuses 1A, 1B and 1C, for example in each case after the receipt of a data model.

The parameter ZE0 specifies whether or not a manufacturing process is currently running in the respective apparatus. The parameter ZE1 specifies whether further data models for the currently running or planned manufacturing process in this apparatus may be added at all to the respective apparatus. The parameters ZE2 and ZE3 specify the build material or the layer thickness for the manufacturing process currently running or planned in this apparatus. The parameter ZE4 specifies the current construction height for a manufacturing process currently running in this apparatus. If the manufacturing process has not yet been started (as in the case of the apparatus 1A), the current construction height has the value zero. A further parameter ZE5 is the packing density of a manufacturing process currently specified for this apparatus. A further parameter ZE6 is the total construction height (job height) for a manufacturing process currently specified for this apparatus, meaning the maximum dimension in the z-direction, i.e. perpendicular to the layers, which results after the manufacture of the parts to be manufactured currently assigned to this apparatus. A parameter ZE7 specifies the initial packing density. This is a minimum value of the packing density which must be achieved in order for a manufacturing process to be started at all. Finally, the parameters ZE8 and ZE9 specify the maximum achievable construction height in the apparatus and the maximum achievable packing density for which the parts can still be manufactured in a process-stable manner.

An exemplary action of the decision unit 104 for each of the three parts B1 to B3 is explained below. Here, it is assumed that a number of part parameters BP1 to BP7 are transmitted to the control unit 100 together with the data model of a part.

### Part B1

| Type of part parameter | Value |
|---|---|
| X dimension (BP1) | 22.5 mm |
| Y dimension (BP2) | 22.5 mm |
| Z dimension (BP3) | 38 mm |
| material (BP4) | PA2200 |
| layer thickness (BP5) | not specified |
| number of pieces (BP6) | 50 |
| overlap (BP7) | allowed |
| latest completion date | DD.MM.JJJJ |

### Part B2

| Type of part parameter | value |
|---|---|
| X dimension (BP1) | 140 mm |
| Y dimension (BP2) | 140 mm |
| Z dimension (BP3) | 120 mm |
| material (BP4) | not specified |
| layer thickness (BP5) | 120 μm |
| number of pieces (BP6) | 3 |
| overlap (BP7) | allowed |

### Part B3

| Type of part parameter | value |
|---|---|
| X dimension (BP1) | 48.2 mm |
| Y dimension (BP2) | 11.5 mm |
| Z dimension (BP3) | 5 mm |
| volume of part (BP3.1) | mm³ |
| packing density of part (BP3.2) | % |
| material (BP4) | not specified |
| layer thickness (BP5) | 120 μm |
| number of pieces (BP6) | as many as possible |
| | without the total height |
| | being increased |
| overlap (BP7) | not allowed |

It should be noted that the part parameters BP1 to BP3 can also be determined autonomously by the control unit based on the data model. In this case, the part parameters BP1 to BP3 do not have to be transmitted to the control unit 100 in addition to the data model. Here, BP1 and BP2 describe predetermined spatial directions that are perpendicular to one another within the working plane and BP3 describes the direction perpendicular to the working plane, wherein it is assumed that the specified dimensions reflect a predetermined preferred orientation of a part in space during the manufacture thereof. The part parameter BP7 (“overlap”) defines whether a part may be arranged in a region of the working plane in which the scanning regions of different radiation sources that are used for solidifying the build material overlap one another. An arrangement in an overlap region can adversely affect the part quality. The latest completion date can represent an additional factor as to whether a part is to be manufactured in a prioritized manner.

With regard to the part B1, the decision unit 104 first of all excludes an assignment of this part to the manufacturing apparatus 1C since a build material other than that specified for the part B1 is used therein. For the decision as to whether the data model of the part B1 is now transmitted to the manufacturing apparatus 1A or to the manufacturing apparatus 1B for the manufacture thereof, in this example the decision unit 104 carries out a test “nesting”. This means that the number of parts B1 specified by the part parameter BP6 is arranged by way of trial in the construction spaces of the manufacturing apparatus 1A and of the manufacturing apparatus 1B. In both cases, it is determined how the packing density and the final total height would change as a result of an arrangement, which is illustrated in FIG. 4. Here, it is also taken into account that parts whose manufacture has not yet been started can be arranged differently. For the manufacturing apparatus 1A in which a manufacturing process has not yet been started, this means that all parts in the construction space can be changed in their position during the test nesting. In the case of the manufacturing apparatus 1B in which a manufacturing process has already been started, it is determined on the basis of the status and property parameter ZE4 (current height layer stack) for which of the objects already assigned to the manufacturing apparatus 1B the manufacture has not yet been started. In the right half of FIG. 4, these have a different color or shading and lie completely above a Z position in the construction space specified by the part parameter ZE4.

In the present example, the decision unit 104 determines on the basis of the test nesting that the packing density in the manufacturing apparatus 1A would increase from 4% to 4.7% as a result of the respective assignment of the parts B1 and the packing density in the manufacturing apparatus 1B would increase from 9.6% to 10.4%. In both cases, the final total height would not be different from the initial total height ZE6. Thus, both manufacturing apparatuses would be approximately equal even if the increase in the packing density, which is considered to be advantageous, in the case of the manufacturing apparatus 1B were slightly greater. However, what is decisive for the ultimate assignment of the parts B1 to the manufacturing apparatus 1B by the decision unit 104 is that a manufacturing process in the manufacturing apparatus 1A could not yet start even after the assignment of the parts B1 to the manufacturing apparatus 1A since the specified initial packing density ZE7 of 6%, i.e., the minimum packing density to be exceeded for a start of a manufacturing process, would not yet have been reached.

With respect to part B2, the decision unit 104 first of all excludes an assignment of this part to the manufacturing apparatus 1B since a layer thickness other than that specified for the part B2 is used therein. For the decision as to whether the data model of the part B2 is now transmitted to the manufacturing apparatus 1A or to the manufacturing apparatus 1C for the manufacture thereof, the decision unit 104 again carries out a test “nesting”. In other words, the number of parts B2 specified by the part parameter BP6 is arranged by way of trial in the construction spaces of the manufacturing apparatus 1A and of the manufacturing apparatus 1C. Again, in both cases it is determined how the packing density and the final total height would change as a result of an arrangement. Here, it is also taken into account that parts in a manufacturing apparatus whose manufacture has not yet been started can be arranged differently. For the manufacturing apparatus 1A in which a manufacturing process has not yet been started, this means that the positions of all parts in the construction space can be changed during the test nesting. In the manufacturing apparatus 1C in which a manufacturing process has already been started, it is determined on the basis of the status and property parameter ZE4 (current height layer stack) for which of the objects already assigned to the manufacturing apparatus 1C the manufacture has not yet been started.

In the present case, the decision unit 104 determines on the basis of the test nesting that as a result of the respective assignment of the parts B2 the packing density would increase from 4% to 7.33% in the manufacturing apparatus 1A and the packing density would decrease from 10% to 9.46% in the manufacturing apparatus 1C. In the case of the manufacturing apparatus 1C, the final total height would increase from 295 mm to 343.6 mm and in the case of the manufacturing apparatus 1A, it would remain the same. Therefore, the decision unit 104 will transmit the data model of the part B2 to the manufacturing apparatus 1A in which then a manufacturing process can be started since the specified initial packing density ZE7 of 6% is exceeded as a result of the assignment of the data model for the manufacture of the parts B2.

With respect to part B3, the decision unit 104 first of all excludes an assignment of this part to the manufacturing apparatus 1A since a layer thickness other than that specified for the part B3 is used therein. When deciding whether the data model of the part B3 is to be transmitted to the manufacturing apparatus 1B or to the manufacturing apparatus 1C, the decision unit 104 takes into account that the initial total height ZE6 shall not change as a result of the additional manufacture of the parts B3. Here, the manufacturing apparatus 1C shows advantages due to the larger dimensions of the construction space parallel to the working plane (apparent in FIG. 2), which would also result from a test nesting. The decision unit 104 therefore transmits the data model of the part B3 to the manufacturing apparatus 1C. The part volume BP3.1 can serve for assessing the resulting packing density. The part packing density BP3.2 describes the packing density that the parts have within a cuboidal “bounding box” around the parts. This parameter can also be used to classify the part according to “nesting” suitability.

The procedure explained with reference to the three parts B1 to B3 is described again in general terms with reference to the method sequence in FIG. 7:

In a first step S1, first data models of first parts to be manufactured are received by the control device 100 and in step S12 status and property parameters of additive manufacturing apparatuses connected to the control device 100 are received. Then, in principle, an assignment of a specific first data model to a specific additive manufacturing apparatus can already be carried out by the control device 100 in a step S3. Optionally, a test nesting of the first data model(s) in some elegible additive manufacturing apparatuses is carried out beforehand in a step S21, optionally by means of additional changes in the arrangement of second data models already assigned to the additive manufacturing apparatus in the construction space in a step S211.

It should also be noted that the control device 100/decision unit 104 can optionally also assign second data models already assigned to a manufacturing apparatus to another manufacturing apparatus in order to create space in the construction space for the first data model to be added. For this purpose, it is advantageous if a further part parameter is available in addition that specifies whether the parts can also be manufactured (optionally in parallel) on different additive manufacturing apparatuses. In the “renesting” just described, the already assigned second data models that are assigned to another manufacturing apparatus would have the role of a first data model.

Furthermore, the control apparatus 100 can be designed such that it receives information about first data models that are still to be expected to be manufactured, wherein the respective information does not yet contain all details and can be limited only to the fact that orders for the data model to be manufactured will arrive within a given period of time (for example until 11:59 p.m.). In such a case, by default the control apparatus 100 can in each case activate or optionally extend holding times (HT) of manufacturing apparatuses in which all manufacturing processes have already been completed, even if not all details for first data models still to be manufactured are yet available.

1. A computer-aided method for controlling a plurality of additive manufacturing apparatuses, each of which is suitable for simultaneously manufacturing a plurality of three-dimensional objects, wherein an object is manufactured by means of an additive manufacturing apparatus by applying and solidifying a building material,
wherein a manufacturing process in each of the additive manufacturing apparatuses is controlled in each case by a control data set that specifies the position and orientation of the objects to be manufactured in a construction space of the additive manufacturing apparatus, wherein the method comprises the following steps:
receiving a number of first computer-based data models each of which geometrically describes a first object to be manufactured by means of an additive manufacturing apparatus,
receiving status data and/or property parameters of a plurality of additive manufacturing apparatuses, to each of which at least one second computer-based data model of a second object to be manufactured in the additive manufacturing apparatus has been assigned,
transmitting at least one first computer-based data model to a target manufacturing apparatus selected from the plurality of additive manufacturing apparatuses for a manufacture of the first object described by the first computer-based data model by means of the target manufacturing apparatus,
wherein the target manufacturing apparatus to which the at least one first computer-based data model will be transmitted is selected on the basis of a rule-based automatic decision in which the received status data and/or property parameters are taken into account.

2. The method of claim 1, wherein
the number of control data sets of the number of additive manufacturing apparatuses is modified by way of trial such that a modified control data set specifies in each case the position and orientation of the number of first objects and the number of second objects in the construction space of the respective active additive manufacturing apparatus, and
the target manufacturing apparatus for a manufacture of the first objects described by the number of first computer-based data models is selected on the basis of the control data sets modified by way of trial.

3. The method of claim 1, wherein the status data received from the additive manufacturing apparatuses contain information about the construction progress in the manufacture of second objects.

4. The method of claim 1, wherein the at least one first computer-based data model is transmitted to a target manufacturing apparatus in which the manufacture of a second object has already started.

5. The method of claim 1, wherein placement information is transmitted to the target manufacturing apparatus, which placement information specifies a placement of the first objects in a construction space of the additive manufacturing apparatus such that at least one first object and at least one second object are manufactured with temporal overlap.

6. The method of claim 1, wherein the property parameters specify a maximum total packing density and/or minimum total construction height in the target manufacturing apparatus that can be achieved for specified boundary conditions.

7. The method of claim 6, wherein the status data contain information about the packing density and/or construction height resulting from the manufacture of the second objects in the additive manufacturing apparatus and
the rule-based decision takes into account the total packing density and/or total construction height resulting from the joint manufacture of first and second objects in the additive manufacturing apparatus.

8. The method of claim 6, wherein the rule-based decision takes into account the change in the packing density and/or construction height respectively resulting from the joint manufacture of first and second objects in an additive manufacturing apparatus.

9. The method of claim 6, wherein the rule-based decision is made in such a way that a first computer-based data model is transmitted to that additive manufacturing apparatus for which, in comparison to the other ones of the plurality of additive manufacturing apparatuses, the packing density resulting from the joint manufacture of first and second objects in the additive manufacturing apparatus assumes a maximum value and/or the total construction height resulting from the joint manufacture of first and second objects in the additive manufacturing apparatus assumes a minimum value.

10. The method of claim 1, wherein at least one second computer-based data model of a second object to be manufactured in the target manufacturing apparatus, the manufacture of which has not yet been started before the transmission of the at least one first computer-based data model, is transferred to an additive manufacturing apparatus other than the target manufacturing apparatus in order to be manufactured in the other manufacturing apparatus.

11. The method of claim 1, wherein for at least one, preferably for all, of the plurality of additive manufacturing apparatuses, to each of which at least one second computer-based data model of a second object to be manufactured in the additive manufacturing apparatus has been assigned, the control data set specifies the manufacture of generic support structures, which can serve as support structures for added first objects during the manufacturing process of the same.

12. The method of claim 1, wherein object parameters are received in addition to the first data models, which object parameters specify boundary conditions for the additive manufacture of objects that are geometrically described by the first data models.

13. A control device for controlling a plurality of additive manufacturing apparatuses, each of which is suitable for simultaneously manufacturing a plurality of three-dimensional objects, wherein an object is manufactured by means of an additive manufacturing apparatus by applying and solidifying a building material, wherein the apparatus comprises:
an object data input interface for receiving a plurality of first computer-based data models each of which geometrically describes a first object to be manufactured by means of an additive manufacturing apparatus,
a status data input interface for receiving status data of a number of additive manufacturing apparatuses, to each of which at least one second computer-based data model of a second object to be manufactured in the additive manufacturing apparatus has been assigned, an object data output interface for transmitting at least one first computer-based data model to a target manufacturing apparatus selected from the plurality of additive manufacturing apparatuses for a manufacture of the first object described by the first computer-based data model by means of the target manufacturing apparatus, and
a decision unit which is configured to select the target manufacturing apparatus to which the at least one first computer-based data model will be transmitted on the basis of a rule-based automatic decision in which the received status data and/or property parameters are taken into account.

14. A method of manufacturing a plurality of three-dimensional objects with a plurality of additive manufacturing apparatuses, each of which is suitable for simultaneously manufacturing a plurality of three-dimensional objects, wherein an object is manufactured by means of an additive manufacturing apparatus by applying and solidifying a building material,
wherein the method of manufacturing comprises a computer-aided method of claim 1.

15. The method of claim 14, wherein the manufacture of a second object, to which a second computer-based data model has been assigned, has already started in the target manufacturing apparatus and is continued without interrupting the manufacturing process, wherein after the transmission of the first computer-based data model both the first object and the second object are manufactured by the target manufacturing apparatus.

16. A manufacturing system with a plurality of additive manufacturing apparatuses, each of which is suitable for simultaneously manufacturing a plurality of three-dimensional objects with temporal overlap, wherein an object is manufactured by means of an additive manufacturing apparatus by applying and solidifying a building material, and a control device according to claim 13 which is connected to the plurality of additive manufacturing apparatuses.

17. A computer program comprising program code means for executing all steps of a method according to claim 1 when the computer program is executed by means of a data processor.
